(19) United States
(12) Patent Application Publication
(10) Pub. No.: US 2019/0300724 A1
(43) Pub. Date: Oct. 3, 2019

(54) Covalently Attached Antioxidant Coatings

(71) Applicant: Xiaoxi Kevin Chen, Natick, MA (US)

(72) Inventor: Xiaoxi Kevin Chen, Natick, MA (US)

(73) Assignee: Medical Surface Inc., Natick, MA (US)

(21) Appl. No.: 16/373,536

(22) Filed: Apr. 2, 2019

Related U.S. Application Data
(60) Provisional application No. 62/651,349, filed on Apr. 2, 2018.

(51) Int. Cl. C09D 5/08; C08J 7/16; G02B 1/14

(52) U.S. Cl. CPC C09D 5/086; C08J 2383/04; G02B 1/14; C08J 7/16

(57) ABSTRACT

The present invention discloses methods for producing a covalently attached antioxidant coating using a multi-step coating process consisting of (1) exposing the substrate surface to plasma polymerization to produce a surface containing functional groups; (2) contacting the surface containing functional groups with crosslinking agents to produce a reactive surface; (3) contacting the reactive surface with a solution of one or more antioxidant compounds or a solution of one or more antioxidant-containing polymers. Alternatively, the third step is replaced by (3) contacting the reactive surface with a solution of one or more polymers to produce a polymer coated surface and (4) covalently attaching one or more antioxidant compounds to the polymer coated surface.

### CROSS-REFERENCE TO RELATED APPLICATION

This application claims priority of U.S. Provisional Patent Application No. 62/651,349, filed Apr. 2, 2018, the entire contents of which are incorporated by reference herein.

### FIELD OF THE INVENTION

The present invention discloses methods for producing a covalently attached antioxidant coating using a multi-step coating process consisting of (1) exposing the substrate surface to plasma polymerization to produce a surface containing functional groups; (2) contacting the surface containing functional groups with crosslinking agents to produce a reactive surface; (3) contacting the reactive surface with a solution of one or more antioxidant compounds or a solution of one or more antioxidant-containing polymers. Alternatively, the third step is replaced by (3) contacting the reactive surface with a solution of one or more polymers to produce a polymer coated surface and (4) covalently attaching one or more antioxidant compounds to the polymer coated surface.

### BACKGROUND OF THE INVENTION

The oxidative degradation of lipids, or lipid peroxidation, is caused by a free radical chain reaction process. The chemical products of this oxidation are known as lipid peroxides (LPOs) or lipid oxidation products (LOPs). On the surfaces of medical devices that adsorb lipids to their surfaces, these LPOs are suspected of detrimental effects in the surrounding tissues.

Coating of antioxidants on the surface of medical devices will help inhibit lipid peroxidation and the generation of LPOs. In order to prolong the effect of antioxidants, the antioxidants need to be covalently attached to the surface so that they will not diffuse away from the surface in aqueous environment.

### SUMMARY OF THE INVENTION

A method is disclosed herein for covalently attaching antioxidant compounds on the surfaces of a substrate by first subjecting the substrate to plasma polymerization to produce functional groups on the surface, followed by converting the functional groups to reactive groups through cross linking agents, followed by covalently attaching the antioxidant compounds on the surface through reactions with the reactive groups.

In the first step of coating, the substrate surfaces are exposed to plasma polymerization of monomers containing functional groups such as carboxyl groups or amino groups. As a result of plasma polymerization, the surface is covered with a thin layer of polymer containing the corresponding functional groups.

In the next step of coating, the substrate surfaces are brought into contact with a solution of a cross linking agent to convert the surface functional groups to reactive groups, such as N-hydroxysuccinimide (NHS) groups.

In the third step of coating, the substrate surfaces are brought into contact with a solution of antioxidant compounds, such as glutathione or L-cysteine, or a solution of antioxidant containing polymers, such as poly-L-cysteine to create an antioxidant coating.

Alternatively, the third step is replaced by contacting the substrate surfaces with a polymer solution to create a polymer coated surface, followed by covalently attaching antioxidant compounds or antioxidant containing polymers on the polymer surface.

One advantage of the disclosed method is that the antioxidant compounds are covalently attached to the substrate surface, resulting in a durable antioxidant coating.

A further advantage of the disclosed method is that this coating method can apply to inert, hard-to-adhere substrates such as polypropylene and fluoropolymers.

These and other features of the invention will be better understood through a study of the following detailed description and accompanying drawings.

### BRIEF DESCRIPTION OF THE FIGURES

FIG. 1 is a drawing representing an example of the subject invention antioxidant coating method. In this example, the substrate is first coated using a plasma polymerization step to generate a surface with carboxyl groups (Step 1), followed by a linker reaction step to generate a surface with N-hydroxysuccinimide (NETS) groups (Step 2), followed by the coating of antioxidant compounds containing amino groups or the coating of a polymer containing amino groups and antioxidant groups. This example is further described in Example A and B.

### DETAILED DESCRIPTION OF THE INVENTION

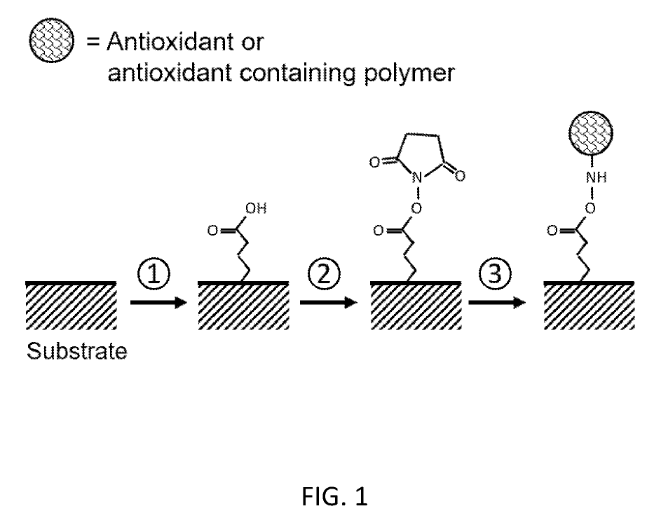

With reference to FIG. 1 as an example, in the first step a substrate is subjected to plasma polymerization coating to produce functional groups such as carboxyl or amino groups on the surface. In the second step the functional group modified surface is brought into contact with a solution of linkers which react with the functional groups to generate a reactive surface. In the third step the reactive surface is brought into contact with a solution of antioxidants or antioxidant containing polymers.

Any known technique can be used to generate the plasma glow discharge for plasma polymerization. The plasma may be generated using AC or DC power, radio-frequency (RF) power or micro-wave frequency power. Preferably, the plasma system is driven by a single radio-frequency (RF) power supply; typically at 13.56 MHz. The plasma system can either be capacitively coupled plasma, or inductively coupled plasma.

Monomer compounds which can be used in the plasma polymerization coating include propionic acid, acrylic acid, allyamine, and diaminopropane.

Linkers used in the second coating step are chosen to have reactivity with the surface functional groups created in the first coating step and create a reactive surface for the third coating step. For carboxyl functional groups, the preferred linker solution contains a carbodiimide such as 1-Ethyl-3-(3-dimethylaminopropyl)carbodiimide and a more stable amine reactive compound such as N-hydroxysuccinimide. For amino functional groups, the preferred linker solution contains a bifunctional N-hydroxysuccinimide linker such as NHS-PEG-NHS.

Antioxidants which can be used in the third step include compounds containing thiol groups such as glutathione, cysteine, acetylcysteine, poly-L-cysteine. The thiol (sulfhydryl) group confers antioxidant effects and is able to reduce free radicals.

Alternatively, the third step can be replaced by contacting the substrate surfaces with a polymer solution to create a polymer coated surface, followed by covalently attaching antioxidant compounds or antioxidant containing polymers on the polymer surface.

### EXAMPLES

### Example A

Silicone substrates were coated with the subject invention method. The substrates were first treated with plasma polymerization of acrylic acid in a radiofrequency plasma glow discharge chamber. The plasma polymerization treated substrates were then soaked in a 100 mM 1-Ethyl-3-(3-dimethylaminopropyl)carbodiimide/N-hydroxysuccinimide solution for 20 minutes and then rinsed with water. The substrates were then soaked in a solution of 20 mg/mL glutathione in a buffer consisting of 50 mM Phosphate, 50 mM NaCl, 2 mM EDTA, pH 7.4 for 2 hours and then rinsed extensively with the buffer.

### Example B

Silicone substrates were coated with the subject invention method. The substrates were first treated with plasma polymerization of acrylic acid in a radiofrequency plasma glow discharge chamber. The plasma polymerization treated substrates were then soaked in a 100 mM 1-Ethyl-3-(3-dimethylaminopropyl)carbodiimide/N-hydroxysuccinimide solution for 20 minutes and then rinsed with water. The substrates were then soaked in a solution of 10 mg/mL L-cysteine in a buffer consisting of 50 mM Phosphate, 50 mM NaCl, 2 mM EDTA, pH 7.4 for 1 hour and then rinsed extensively with the buffer.

### Example C

The amounts of thiols covalently attached on the surface were quantified using Ellman's Reagent 5,5-dithio-bis-(2-nitrobenzoic acid) (DTNB) colorimetric assay. Silicone substrates coated with the subject invention method, as described in Examples A and B, were incubated in 0.5 mM DTNB in a buffer consisting of 50 mM Phosphate, 50 mM NaCl, 2 mM EDTA, pH 7.4. After 30-minute incubation, the DTNB solution was measured in a UV-VIS spectrometer for absorption at 412 nm. Standard solutions of glutathione and L-cysteine with known concentrations were also incubated with DTNB to generate the standard curve. The amounts of glutathione and L-cysteine attached on the surface were found to be between 30-60 nmol/cm².

The present teachings can be embodied in other specific forms without departing from the spirit or essential characteristics thereof. The foregoing embodiments are therefore to be considered in all respects illustrative rather than limiting on the present teachings described herein. The scope of the present teachings is thus indicated by the appended claims rather than by the foregoing description, and all changes that come within the meaning and range of equivalency of the claims are intended to be embraced therein.

What is claimed is:

1. A method for producing a covalently bound antioxidant coating on a substrate containing a multi-step process consisting of (1) exposing said substrate surface to plasma polymerization to produce a surface containing functional groups; (2) contacting said surface containing functional groups with crosslinking agents to produce a reactive surface; (3) contacting said reactive surface with a solution of one or more antioxidant compounds or a solution of one or more antioxidant-containing polymers.

2. A method for producing a covalently bound antioxidant coating on a substrate containing a multi-step process consisting of (1) exposing said substrate surface to plasma polymerization to produce a surface containing functional groups; (2) contacting said surface containing functional groups with crosslinking agents to produce a reactive surface; (3) contacting said reactive surface with a solution of one or more polymers to produce a polymer coated surface; (4) covalently attaching one or more antioxidant compounds to said polymer coated surface.

3. A method of claim 1, wherein said functional groups contain carboxyl group.

4. A method of claim 2, wherein said functional groups contain carboxyl group.

5. A method of claim 1, wherein said functional groups contain amino group.

6. A method of claim 2, wherein said functional groups contain amino group.

7. A method of claim 1, wherein said substrate is a part of a medical device.

8. A method of claim 2, wherein said substrate is a part of a medical device.

9. A method of claim 1, wherein said substrate is a part of a contact lens.

10. A method of claim 2, wherein said substrate is a part of a contact lens.

11. A method of claim 1, wherein said antioxidant compounds contain one or more of the following: acetylcysteine, ascorbic acid, cysteine, glutathione, lipoic acid, melatonin, poly-L-cysteine, uric acid.

12. A method of claim 2, wherein said antioxidant compounds contain one or more of the following: acetylcysteine, ascorbic acid, cysteine, glutathione, lipoic acid, melatonin, poly-L-cysteine, uric acid.
